(19) United States
(12) Patent Application Publication
(10) Pub. No.: US 2008/0118699 A1
(43) Pub. Date: May 22, 2008

(54) Perforated Skin For Acoustic Element, Acoustic Element And Method For Making Same

(75) Inventor: Jean-Pierre Jumel, Croissy sur Seine (FR)

Correspondence Address: YOUNG & THOMPSON, 209 Madison Street, Suite 500, ALEXANDRIA, VA, 22314, US

(73) Assignee: AIRCELLE, HARFLEUR (FR)

(21) Appl. No.: 10/585,869

(22) PCT Filed: Jan. 14, 2005
(86) PCT No.: PCT/FR05/00085

§ 371 Date: Jul. 11, 2006

(30) Foreign Application Priority Data
Jan. 15, 2004 (FR) 0400334

(51) Int. Cl. B32B 5/12; B05D 3/12

(52) U.S. Cl. 428/114; 428/195.1; 427/356

(57) ABSTRACT

A perforated skin consisting of at least one layer (N1-N3) of substantially rectilinear fibers associated with a resin and whose perforations define a regular repeated pattern (a, b, c), characterized in that the perforations affect at least 25% of the skin and in that, at least in a major part of the perforated skin, fibers (C1-C3) of the layer(s) (N1-N3) are uninterrupted by the perforations (P1-P3).

The subject of the present invention is a perforated skin for an acoustic element, an acoustic element incorporating such a skin, and the process for manufacturing said skin.

The term “acoustic element” is understood to mean an element composed of an external skin/honeycomb/internal skin sandwich, said external skin being intended to be placed on the noise source side.

In the field of aeronautics for example, it is necessary to reduce as much as possible the noise produced by the jet engine in the air intake or the ejection system.

For this purpose, acoustic elements formed from an external skin/honeycomb/internal skin sandwich have been proposed, in which the external skin, intended to be located on the noise source side, is perforated in order to allow the sound waves to penetrate the sandwich and be damped therein, the internal skin itself being a solid skin.

Within the context of the present description, the verb “perforate”, and its declinations, is used in the correct sense of “piercing right through”, such as by puncturing, mechanical drilling by a drill, erosion, laser, etc., and not in the sense of making holes in any particular manner.

Composite skins, i.e. those made of fibers and a resin, perforated to an amount of 10-15% are known, such a degree of perforation sparing the fibers sufficiently for the skin to retain an acceptable degree of integrity.

Metal skins perforated to an amount of 30-40% are also known, without the degree of integrity becoming unacceptable, sufficient material remaining between the perforations.

Since composite products are lighter than metal products and since the question of weight is always an extremely important parameter in aeronautics, it would be desirable to be able to have composite skins having a degree of perforations similar to that which is possible to achieve in the case of metal skins. Unfortunately, this is not possible by simply applying the known technique with either an increase in the density of the perforations, or an increase in the size of the perforations, or both, since, in that case, a sufficient number of fibers not affected by the perforations no longer remains and the structural integrity of the skin is no longer assured except by the resin matrix.

One solution is not to perforate a web of resin-preimpregnated fibers, once the resin has cured, but to provide holes by making the web, before it has cured, pass between the spikes of a board in the form of a “fakir's bed of nails”, the removal of the spikes from the board, after curing, resulting in as many holes in the web as there were spikes. In this case, the fibers follow a sinuous path around the holes instead of being cut by the creation of the holes, and the skin has a suitable integrity even with a high percentage of holes. However, apart from the fact that this solution is difficult to implement when it is required to produce a skin of complex shape with a double curvature, it is not completely satisfactory in the sense that the holes are irregular with clumps of resin at the points of divergence/confluence of the fibers upstream/downstream of the holes.

Another solution consists in producing the acoustic element in the form of a dish, which constitutes the internal skin and on which the honeycomb core and the perforated external skin are bonded. The internal skin is therefore the only one for withstanding the forces, and this solution is not very effective from the structural standpoint.

There therefore exists an unsatisfied need for a composite web that is highly perforated but has sufficient integrity, which need is all the more pressing as a high perforation would make it possible to affix, to the skin, a wire mesh in order for the acoustic attenuation to be optimal.

For this purpose, the invention provides a perforated skin for an acoustic element, said skin consisting of at least one web of substantially rectilinear fibers associated with a resin, the perforations in which define a regular repeat pattern, characterized in that the perforations affect at least 25%, and preferably 30-40%, of the skin and in that, at least over a major portion of the skin thus perforated, fibers of said web or webs are interrupted by the perforations.

The resin in question may be either a thermosetting resin or a thermoplastic resin, and the expression “associated with a resin” is understood to cover both the case of preimpregnation of the fibers and the juxtaposition of a film of resin with a web of fibers, or any other technique known in the art.

In a preferred embodiment of the invention, at least some of the fibers of at least one web are substantially parallel to one another and oriented in such a way that they follow a series of parallel channels free of perforations and, better still, the skin comprises at least two webs, in each of which at least certain fibers are substantially parallel to one another, said parallel fibers of one of the webs being oriented in such a way that they follow a first series of parallel channels free of perforations and the parallel fibers of the other web being oriented in such a way that they follow a second series of parallel channels free of perforations, the first series of channels cutting the second series of channels.

The two webs in question may be independent or consist, for example, of the warp yarns and weft yarns of a fabric.

The regular repeat pattern of the perforation may be any pattern, but it will usually be a pattern in the form of equilateral triangles or a pattern in the form of rectangles, and more specifically squares.

In the case of a pattern in the form of equilateral triangles, the skin comprises at least one series of three webs, in each of which at least certain fibers are substantially parallel to one another, each web having its parallel fibers oriented parallel to one of the sides of the equilateral triangle.

In the case of a pattern in the form of rectangles, the skin comprises at least one series of four webs, in each of which at least certain fibers are substantially parallel to one another, two of the webs having their parallel fibers oriented parallel to each of the pairs of sides of the rectangle and the other two webs having their parallel fibers oriented parallel to each of the diagonals of the rectangle.

In one possible embodiment, at least two of said webs belong to a fabric having fibers along a first direction and fibers along a second direction that cuts the first, said fabric being oriented in such a way that at least certain fibers along the first direction and at least certain fibers along the second direction follow channels free of perforations.

The expression “webs of virtually unidirectional fibers” is understood to mean that the fibers are to a very great extent (90-98%) unidirectional. For example, they may be carbon fibers reinforced with 2% of glass fibers that are oriented perpendicular to the carbon fibers.

The fibers may be of any nature provided that they are capable of withstanding the operating conditions, for example carbon fibers, glass fibers or Kelvar fibers. As regards the resin, this will be chosen in particular according to the temperature to which the acoustic element will be subjected in service. Thus, an acoustic element equipping a gas outlet will be exposed to temperatures considerably higher than an element equipping an air intake. Depending on the case, an epoxy resin or a bismaleimide (BMI) resin, for example, may be used.

As indicated above, the invention also relates to an acoustic element incorporating the skin described above and to a process for manufacturing said skin.

As regards the acoustic element, this is formed, as indicated above, from an external skin/honeycomb/internal skin sandwich and said external skin is formed by the skin according to the invention.

Preferably, said external skin is fastened, on its face opposite the honeycomb, to a porous woven metal fabric from 1 to 2/10 mm in thickness and having a gas penetration resistance of between 20 and 40 Pa·s/m (rayls).

This metal fabric is formed from fine metal wires, generally made of stainless steel in order to avoid “galvanic” corrosion phenomena. The weave of such a woven metal fabric is very tight and may result in a cloth or, more usually, in a reps.

As regards the process, this comprises, prior to the perforation step, a step of depositing said webs on a former for shaping purposes, and it is characterized in that:
in respect of the deposition, one lays:
   at least one web of unidirectional or virtually unidirectional fibers associated with a resin in a first direction and
   at least one second web of unidirectional or virtually unidirectional fibers associated with a resin in a second direction that cuts the first; and
in respect of the perforation, one applies a pattern of such a geometry and of such an orientation relative to said first and second directions that at least certain fibers of the first and second webs remain uninterrupted.

If a skin having a pattern of perforations in the form of equilateral triangles is to be manufactured:
in respect of the deposition, one lays:
   at least one first web of unidirectional or virtually unidirectional fibers associated with a resin in a first direction, 0°,
   at least one second web of unidirectional or virtually unidirectional fibers associated with a resin in a second direction, at +60° to the first direction and
   at least one third web of unidirectional or virtually unidirectional fibers associated with a resin in a third direction, at −60° to the first direction; and
in respect of the perforation, one applies a pattern in the form of equilateral triangles oriented in such a way that the first direction corresponds to that of one side of an equilateral triangle of the pattern.

If a skin having a pattern of perforations in the form of rectangles is to be manufactured, according to a first variant:
in respect of the deposition, one lays:
   at least one first web of unidirectional or virtually unidirectional fibers associated with a resin in a first direction, 0°,
   at least one second web of unidirectional or virtually unidirectional fibers associated with a resin in a second direction, at +b 90° to the first direction and
   at least one third and a fourth web of unidirectional or virtually unidirectional fibers associated with a resin in third and fourth directions along each of the respective diagonals of a rectangle of the future perforation pattern; and
in respect of the perforation, one applies a pattern in the form of rectangles, which are oriented in such a way that the third and fourth directions correspond to those of the diagonals of a rectangle of the pattern.

One particular case of a rectangle is of course a square. In this case, the third and fourth directions will be at +45° and −45° to the first direction, respectively.

In a second variant applicable to the case of a pattern in the form of squares:
in respect of the deposition, one lays:
   in a first direction, at least one fabric layer associated with a resin and comprising warp yarns and weft yarns substantially perpendicular to one another, the direction of said warp yarns being taken as the first direction and
   in a second direction, 45° to the first direction, at least one fabric layer associated with a resin and comprising warp yarns and weft yarns substantially perpendicular to one another, the direction of said warp or weft yarns being taken as the second direction; and
in respect of the perforation, one applies a pattern of squares oriented in such a way that the first direction corresponds to that of a diagonal of a square of the pattern.

In all cases, during deposition, care is taken to orient at least some of the fibers which will remain uninterrupted after perforation in a direction corresponding to a direction of maximum stress of the element, once in service.

Of course, deposition on nonplanar formers means that the fibers do not have a constant orientation and, as a consequence, it will be necessary for the perforating machine to be suitably programmed so that the operation always takes into account the changes in orientation of the fibers.

The invention will be more clearly understood on reading the following description given with reference to the appended drawings, in which:

FIG. 1 is a diagram showing, in an enlarged cross section, an acoustic element to which the invention applies;

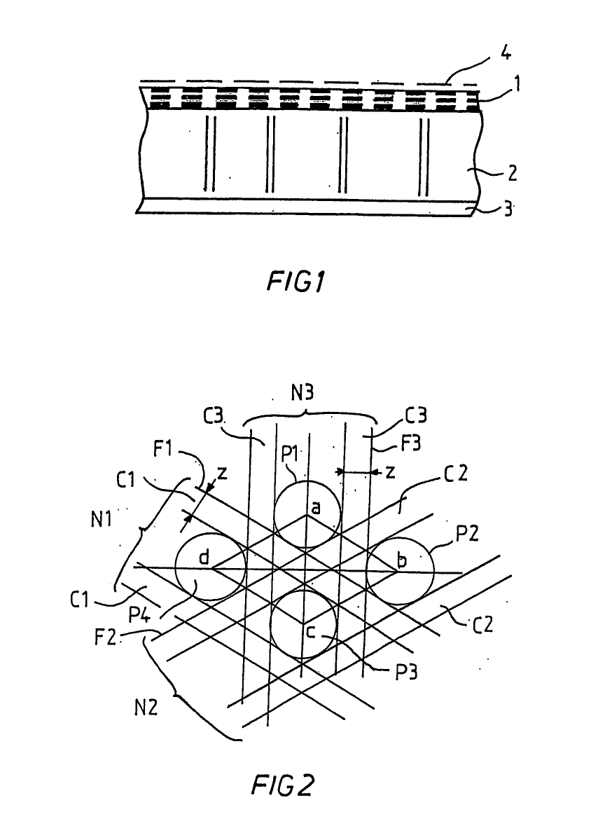

FIG. 2 is a diagram showing the orientation of the fibers in the case of a perforation pattern in the form of equilateral triangles; and

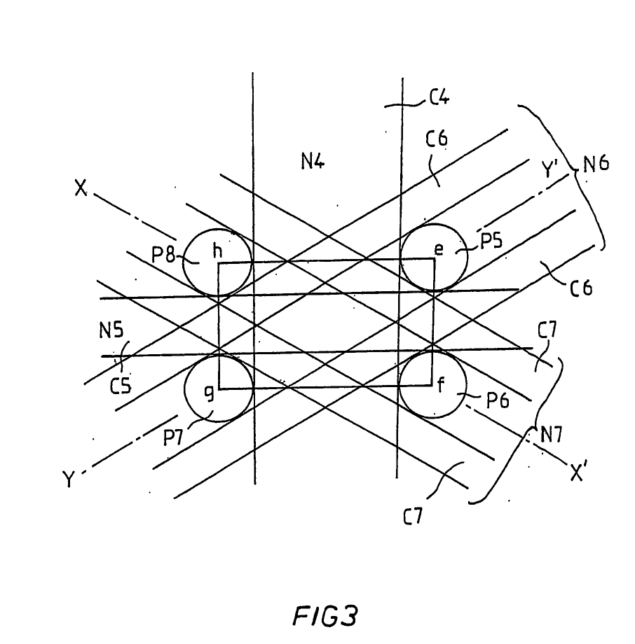

FIG. 3 is a diagram showing the orientation of the fibers in the case of a perforation pattern in the form of rectangles.

As is apparent from FIG. 1, the acoustic element comprises a perforated external skin 1, a honeycomb layer 2 and an unperforated internal skin 3. The skin 1 is perforated in such a way that, taking into account the perforations blocked off by the joining of said skin to the honeycomb, there are an average of three perforations per cell of the honeycomb. A metal cloth 4, such as a reps, 1 to 2/10 mm in thickness is bonded to the perforated skin 1 in order to increase the acoustic damping effect.

Turning to FIG. 2, this shows an arrangement of perforations P1, P2 and P3 in the form of an equilateral triangle a,b,c (or perforations P1, P3, P4 in the form of an equilateral triangle a,c,d). The perforations may for example have a diameter of 1.55 mm and the sides of the triangle may have a length of 2.53 mm. It will be understood that, for such a perforation density, randomly distributed fibers would inevitably be cut for the most part and this would result in insufficient integrity of the skin. Thus, to avoid this being the case, the invention provides for a particular relationship to be respected between the orientation of the fibers and the geometry of the perforation repeat pattern.

Thus, as may be seen, a first web N1 of unidirectional fibers is placed in such a way that its fibers, such as F1, are parallel to the side a,b of the triangle, a second web N2 of unidirectional fibers is placed in such a way that its fibers F2 are parallel to the side b,c of the triangle, and a third web N3 of unidirectional fibers is placed in such a way that its fibers F3 are parallel to the side a,c of the triangle. Of course, the formation of the perforations P1, P2 and P3 will cut fibers in the webs N1, N2 and N3, but channels C1, C2 and C3, of width z, of fibers spared by this operation will remain and the fibers thus uninterrupted will ensure sufficient integrity of the perforated skin.

FIG. 3 shows an arrangement of perforations P5, P6, P7 and P8 in the form of a rectangle e,f,g,h, the directions X-X′ and YY′ corresponding to those of the diagonals of said rectangle. In order not to overly burden the figure, to illustrate the webs only the channels of corresponding uninterrupted fibers have been shown. As may be seen, a first web N4 of unidirectional fibers is placed in such a way that its fibers are parallel to the sides e,f and h,g of the rectangle, a second web N5 of unidirectional fibers is placed in such a way that its fibers are parallel to the sides e,h and f,g of the rectangle, and a third web N6 of unidirectional fibers is placed in such a way that its fibers are parallel to the diagonal e,g (=Y−Y′) and a fourth web N7 of unidirectional fibers is placed in such a way that its fibers are parallel to the diagonal f,h (=X,X′). Here again, the formation of the perforations P5-P8 will cut fibers in the webs N4-N7, channels C4-C7 of fibers spared by this operation will remain and the fibers thus uninterrupted will ensure sufficient integrity of the perforated skin.

It will be understood that the fibers of the web N4 and those of the web N5 could belong to a woven fabric, the fibers of which would constitute the warp and weft respectively.

In a first embodiment variant, the fiber webs N4-N7 are independent of one another. In a second variant, the fibers of two perpendicular webs, such as N4 and N5, or N6 and N7, may in fact be, on the one hand, the warp yarns and, on the other hand, the weft yarns of a woven fabric.

The above description referred to the use of three fiber webs with regard to the pattern in the form of equilateral triangles and four fiber webs with regard to the pattern in the form of rectangles, but the skin may comprise further webs. Thus, in a preferred embodiment of perforations with a pattern in the form of equilateral triangles, the skin will comprise six plies oriented at 0°/+60°/−60°/−60°/+60°/0°

Furthermore, as indicated above, the invention relates to the production of perforated skins in which the perforations define a regular repeat pattern. The patterns that have been specifically described and/or illustrated are merely nonlimiting examples. For example, they could just as well be hexagonal patterns, octagonal patterns, etc.

1-15. (canceled)

16. A perforated skin for an acoustic element, said skin consisting of at least one web of substantially rectilinear fibers associated with a resin, wherein the perforations define a regular repeat pattern and affect at least 25% of the skin, the fibers of said web or webs being uninterrupted by the perforations at least over a major portion of the skin thus perforated.

17. The skin as claimed in claim 16, which is perforated to 30-40%.

18. The skin as claimed in claim 16, wherein at least some of the fibers of at least one web are substantially parallel to one another and oriented in such a way that they follow a series of parallel channels free of perforations.

19. The skin as claimed in claim 16, which comprises at least two webs, in each of which at least certain fibers are substantially parallel to one another, said parallel fibers of one of the webs being oriented in such a way that they follow a first series of parallel channels free of perforations and the parallel fibers of the other web being oriented in such a way that they follow a second series of parallel channels free of perforations, the first series of channels cutting the second series of channels.

20. The skin as claimed in claim 16, in which the regular repeat pattern is an equilateral triangle, said skin comprising at least one series of three webs, in each of which at least certain fibers are substantially parallel to one another, each web having its parallel fibers oriented parallel to one of the sides of the equilateral triangle.

21. The skin as claimed in claim 16, in which the regular repeat pattern is a rectangle, said skin comprising at least one series of four webs, in each of which at least certain fibers are substantially parallel to one another, two of the webs having their parallel fibers oriented parallel to each of the pairs of sides of the rectangle and the other two webs having their parallel fibers oriented parallel to each of the diagonals of the rectangle.

22. The skin as claimed in claim 16, wherein the fibers of said web or webs are unidirectional or virtually unidirectional fibers.

23. The skin as claimed in claim 16, wherein at least two of said webs belong to a fabric having fibers along a first direction and fibers along a second direction that cuts the first, said fabric being oriented in such a way that at least certain fibers along the first direction and at least certain fibers along the second direction follow channels free of perforations.

24. An acoustic element formed from an external skin/honeycomb/internal skin sandwich, said external skin being intended to be placed on the noise source side, wherein said external skin is a skin as claimed in claim 16.

25. An acoustic element formed from an external skin/honeycomb/internal skin sandwich, said external skin being intended to be placed on the noise source side, said external skin being a skin as claimed in claim 16 and being fastened, on its face opposite the honeycomb, to a porous woven metal fabric from 1 to 2/10 mm in thickness and having a gas penetration resistance of between 20 and 40 Pa·s/m.

26. An acoustic element formed from an external skin/honeycomb/internal skin sandwich, said external skin being intended to be placed on the noise source side, said external skin being a skin as claimed in claim 16, and at least some of the fibers of at least one web of said external skin being substantially parallel to one another and oriented in such a way that they follow a series of parallel channels free of perforations

27. An acoustic element formed from an external skin/honeycomb/internal skin sandwich, said external skin being intended to be placed on the noise source side and being a skin as claimed in claim 16, at least some of the fibers of at least one web of said external skin being substantially parallel to one another and oriented in such a way that they follow a series of parallel channels free of perforations, said external skin being fastened, on its face opposite the honeycomb, to a porous woven metal fabric from 1 to 2/10 mm in thickness and having a gas penetration resistance of between 20 and 40 Pa·s/m,

28. A process for manufacturing a skin as claimed in claim 19, which comprises, prior to the perforation step, a step of depositing said webs on a former for shaping purposes, wherein:
in respect of the deposition, one lays:
at least one web of unidirectional or virtually unidirectional fibers associated with a resin in a first direction and
at least one second web of unidirectional or virtually unidirectional fibers associated with a resin in a second direction that cuts the first; and
in respect of the perforation, one applies a pattern of such a geometry and of such an orientation relative to said first and second directions that at least certain fibers of the first and second webs remain uninterrupted.

29. The process for manufacturing a skin as claimed in claim 20, which comprises, prior to the perforation step, a step of depositing said webs on a former for shaping purposes, wherein:
in respect of the deposition, one lays:
at least one first web of unidirectional or virtually unidirectional fibers associated with a resin in a first direction, 0°,
at least one second web of unidirectional or virtually unidirectional fibers associated with a resin in a second direction, at +60° to the first direction and
at least one third web of unidirectional or virtually unidirectional fibers associated with a resin in a third direction, at −60° to the first direction; and
in respect of the perforation, one applies a pattern in the form of equilateral triangles oriented in such a way that the first direction corresponds to that of one side of an equilateral triangle of the pattern.

30. The process for manufacturing a skin as claimed in claim 21, which comprises, prior to the perforation step, a step of depositing said webs on a former for shaping purposes, wherein:
in respect of the deposition, one lays:
at least one first web of unidirectional or virtually unidirectional fibers associated with a resin in a first direction, 0°,
at least one second web of unidirectional or virtually unidirectional fibers associated with a resin in a second direction, at +90° to the first direction and
at least one third and a fourth web of unidirectional or virtually unidirectional fibers associated with a resin in third and fourth directions along each of the respective diagonals of a rectangle of the future perforation pattern; and
in respect of the perforation, one applies a pattern in the form of rectangles, which are oriented in such a way that the third and fourth directions correspond to those of the diagonals of a rectangle of the pattern.

31. The process for manufacturing a skin as claimed in claim 21, which comprises, prior to the perforation step, a step of depositing said webs on a former for shaping purposes, in which the rectangular pattern is a square pattern, wherein:
in respect of the deposition, one lays:
in a first direction, at least one fabric layer associated with a resin and comprising warp yarns and weft yarns substantially perpendicular to one another, the direction of said warp yarns being taken as the first direction and
in a second direction, 45° to the first direction, at least one fabric layer associated with a resin and comprising warp yarns and weft yarns substantially perpendicular to one another, the direction of said warp or weft yarns being taken as the second direction; and
in respect of the perforation, one applies a pattern of squares oriented in such a way that the first direction corresponds to that of a diagonal of a square of the pattern.

32. A process for manufacturing a skin as claimed in claim 16, which consists, during the deposition, in orienting at least some of the fibers which will remain uninterrupted after perforation in a direction corresponding to a direction of maximum stress of the element, once in service.

33. The skin as claimed in claim 17, wherein at least some of the fibers of at least one web are substantially parallel to one another and oriented in such a way that they follow a series of parallel channels free of perforations.

34. The skin as claimed in claim 17, which comprises at least two webs, in each of which at least certain fibers are substantially parallel to one another, said parallel fibers of one of the webs being oriented in such a way that they follow a first series of parallel channels free of perforations and the parallel fibers of the other web being oriented in such a way that they follow a second series of parallel channels free of perforations, the first series of channels cutting the second series of channels.

35. The skin as claimed in claim 17, in which the regular repeat pattern is an equilateral triangle, said skin comprising at least one series of three webs, in each of which at least certain fibers are substantially parallel to one another, each web having its parallel fibers oriented parallel to one of the sides of the equilateral triangle.
